(19) United States
(12) Patent Application Publication
(10) Pub. No.: US 2008/0050591 A1
(43) Pub. Date: Feb. 28, 2008

(54) Method to Manufacture a Non Sintered Metal Fiber Medium

(75) Inventors: Constantine Stournaras, Chalkdia (GR); Constantina Andreouli, Vathi Avlidos (GR); Zoi Tatoudi, Chalkdia (GR); Frank Verschaeve, Otegem (BE); Carl Vromant, De Pinte (BE); Gerrit Betsbrugge, Bellegem (DE)

Correspondence Address: FOLEY AND LARDNER LLP;SUITE 500, 3000 K STREET NW, WASHINGTON, DC, 20007, US

(73) Assignee: NV BEKAERT SA

(21) Appl. No.: 11/578,579

(22) PCT Filed: Mar. 24, 2005
(86) PCT No.: PCT/EP05/51380

§ 371 Date: Sep. 7, 2007

(30) Foreign Application Priority Data
Apr. 15, 2004 (EP) 04 101 538.9

(51) Int. Cl. B01D 39/20

(52) U.S. Cl. 428/401; 162/146

(57) ABSTRACT

The invention relates to a method for manufacturing a non-sintered metal fiber medium, comprising the steps of: providing metal fibers; making a slurry comprising the metal fibers and a binding agent by mixing these metal fibers and the binding agent, possibly with a solvent such as water; casting a layer of the slurry on a support using an applicator; solidifying this slurry, providing a non-sintered metal fiber medium comprising the metal fibers and the binding agent. The invention relates also to a non-sintered metal fiber medium.

### FIELD OF THE INVENTION

The present invention relates to a method of manufacturing of a non-sintered metal fiber medium comprising metal fibers and a polymer binder. The present invention relates also to a non-sintered metal fiber medium comprising metal fibers and a polymer binder.

### BACKGROUND OF THE INVENTION

A non-sintered metal fiber medium comprising metal fibers and a polymer binder is known in prior art as intermediate product during the production of a sintered metal fiber medium using the wet lay down method, as described in WO98/43756, EP933984A, JP11-131105, JP61-225400 and JP61-223105. The metal fibers are brought in a slurry, which slurry is poured on a screen. The water is sucked from the slurry through the screen. The remaining dewatered slurry is then sintered in order to obtain a sintered metal fiber medium. A binding agent is usually used to temporarily bind the metal fibers to each other and so to make the dewatered slurry transportable.

A disadvantage of the wet webbing is that in case of thin or/and relatively short fibers are used, some of the shorter fibers are sucked through the screen, together with the water being removed from the slurry. In case of thin webs made prior to sintering, the dewatering step may suck small or larger holes in the web where few or no fibers are retained for sintering. Also, an imprint of the supporting net, used to support the wet slurry during dewatering, is obtained. The net pattern is noticed on the dewatered web as repetitive thinner spots. Using thin web layers, this may result in non-homogeneity.

As a result, the dewatered slurry being the non sintered meal fiber medium, may have inhomogeneous zones less fibers are present.

Especially in case fibers with small equivalent diameter, e.g. 2 μm to 6 μm, are used, the phenomena of sucking fibers with the water during dewatering is noticed. This because usually the part of fibers with smaller lengths is larger, the finer the fibers are. As a result, more fibers with a small length are sucked with the water during dewatering in case of fibers with small equivalent diameter.

### SUMMARY OF THE INVENTION

It is an object of the present invention to provide a method for manufacturing a non-sintered metal fiber media which overcomes the drawbacks of prior art. It is an object of the present invention to provide a method of manufacturing a non-sintered metal fiber medium with more homogeneous properties over its surface. It is also an object of the present invention to provide a method of manufacturing a non-sintered metal fiber medium with homogeneous properties over its surface comprising relatively short and/or fine metal fibers. It is further an object of the present invention to provide a method of manufacturing a non-sintered metal fiber medium with homogeneous properties over its surface, which medium has a relatively small thickness.

A method for manufacturing a non-sintered metal fiber medium as subject of the invention comprises the steps as described in claim 1.

Preferably, the slurry used for casting using an applicator, or so-called tape casting, comprises an amount of metal fibers in the range of 2% weight to 40% weight of the slurry, more preferred between 5% weight and 15% weight of the slurry. Apparently, such concentration combined with the tape casting action to provide substantially flat layers of slurry, causes metal fibers to be distributed more homogeneously, so providing metal fiber medium having more homogeneous properties over its surface and in depth of the medium.

Too much metal fibers in the slurry may cause conglomeration of the fibers, causing on its turn inhomogeneous metal fiber distribution throughout the metal fiber medium.

Too little metal fibers in the slurry may cause irregular distribution in the cast metal fiber medium prior to solidification of the slurry.

In a further preferred method, the slurry comprises a solvent for dissolving the binding agent, and during solidification of the slurry, all solvent is removed by evaporation. This has a further advantageous effect on the metal fiber distribution homogeneity over the surface and in depth of the metal fiber medium which results from the further process.

In a first step, metal fibers are to be provided. Any type of metal or metal alloy may be used to provide the metal fibers.

The metal fibers are for example made of steel such as stainless steel. Preferred stainless steel alloys are AISI 300 or AISI 400-serie alloys, such as AISI 316L or AISI 347, or alloys comprising Fe, Al and Cr, stainless steel comprising Chromium, Aluminum and/or Nickel and 0.05 to 0.3% by weight of Yttrium, Cerium, Lanthanum, Hafnium or Titanium, such as e.g. DIN 1.4767 alloys or Fecralloy®, are used. Also Copper or Copper-alloys, or Titanium or Titanium alloys may be used.

The metal fibers can also be made of Nickel or a Nickel alloy.

Metal fibers may be made by any presently known metal fiber production method, e.g. by bundle drawing operation, by coil shaving operation as described in JP3083144, by wire shaving operations (such as steel wool) or by a method providing metal fibers from a bath of molten metal alloy.

In order to provide the metal fibers with their average length, the metal fibers may be cut using the method as described in WO02/057035, or by using the method to provide metal fiber grains such as described in U.S. Pat. No. 4,664,971.

The metal fibers used to provide the non-sintered metal fiber medium are characterized in having an equivalent diameter D and an average fiber length L.

With equivalent diameter of a metal fiber is meant the diameter of an imaginary circle having the same surface as the surface of a radial cross section of the fiber.

Preferably the equivalent diameter D of the metal fibers is less than 100 μm such as less than 65 μm, more preferably less than 361 μm such as 35 μm, 22 μm or 17 μm. Possibly the equivalent diameter of the metal fibers is less than 15 μm, such as 14 μm, 12 μm or 11 μm, or even more preferred less than 9 μm such as e.g. 8 μm. Most preferably the equivalent diameter D of the metal fibers is less than 7 μm or less than 6 μm, e.g. less than 5 μm, such as 1 μm, 1.5 μm, 2 μm, 3 μm, 3.5 μm, or 4 μm.

The metal fibers all have an individual fiber length. As some distribution on these fiber lengths may occur, due to the method of manufacturing the metal fibers, the metal fibers, used to provide a non-sintered metal fiber medium as subject of the invention, have an average fiber length L. This length is determined by measuring a significant number of fibers, according to appropriate statistical standards. The average fiber length of the metal fibers is smaller than 10 mm, e.g. smaller than 6 mm, preferably smaller than 1 mm, such as smaller than 0.8 mm or even smaller than 0.6 mm such as smaller than 0.2 mm. As according to the present invention, substantially all fibers used during the method of manufacturing the non-sintered metal fiber medium will occur in the non-sintered metal fiber medium, the average fiber length L can be measured in a similar way on the non-sintered metal fiber medium.

The metal fibers in the non-sintered metal fiber medium thus may have a ratio of average fiber length over diameter (L/D) which is preferably less than 110, more preferred less than 100, but usually more than 30. An L/D of about 30 to 70 is preferred for metal fibers with equivalent diameter in the range up to 6 μm, in case the metal fibers are obtained by the process as described in WO02/057035, hereby incorporated by reference.

In the second step of the method as subject of the invention, a slurry is to be provided. Although not to be understood as limiting, preferably the slurry, comprising metal fiber, a solvent and a binding agent, preferably has a metal fiber concentration in the range of 20% weight to 40% weight of the slurry. Preferably 10% weight to 15% weight of the slurry is provided by metal fibers. It was found that the smaller the equivalent diameter of the metal fibers, the lower the concentration of metal fibers is kept in order to obtain an homogeneously dispersion of the metal fibers in the slurry.

Alternatively, the slurry comprises a polymer binding agent and metal fibers, which polymer binding agent is heated to reduce its viscosity.

A binding agent for the purpose of the invention is to be understood as a product for thickening the slurry. Preferably a water soluble binding agent is used, e.g. polyvinyl alcohols, methyl cellulose ethers, hydroxypropylmethylcellulose, polyethers from ethylene oxide, acrylic acid polymers or acrylic copolymers. The binding agent is added to the solvent, in a concentration of preferably between 0.5% weight and 30% weight of the slurry. Most preferred, a binding agent is chosen which requires a concentration of less than 20% weight or even less than 15% weight or even less than 10% weight of the slurry, in order to provide the required viscosity. A viscosity range between 1000 cPs and 20000 cPs is preferably used for the slurry. The components of the slurry are blended using appropriate mixing equipment. In case foaming of the slurry occurs, small amounts of a defoaming component is added

In a third step, the slurry is tape cast using an applicator, such as a doctor blade, on a preferably substantially flat surface. In case water is used as solvent, preferably a water repellant surface is used. The clearance of the applicator may be kept relatively small, this is preferably between 0.2 mm and 6 mm, more preferred between 0.2 mm and 3 mm. The speed of movement of the applicator is chosen according to the viscosity of the slurry.

The clearance and thus the thickness of the layer of the slurry is chosen in function of the amount of metal fibers in the slurry, the required thickness and weight per surface unit of the non-sintered metal fiber medium, and the required amount of metal fibers and binder in the non-sintered metal fiber medium.

In a next step, the cast slurry is solidified, forming the non-sintered metal fiber medium which comprises the binding agent and the metal fibers. This is preferably done by evaporating the solvent. A solvent may be used which evaporates easily at ambient temperature. Alternatively, the evaporation may be executed as a drying step in case water was used as solvent. The drying or evaporating may be executed or assisted by air-drying or may be forces by heating the cast slurry, e.g. by forcing heated air over the surface of the cast slurry, or by radiating, e.g. microwave- or IR-radiating.

It is understood that only the solvent, e.g. water is removed, which solvent was not chemically bound to the binding agent.

It is understood that, in case solvent is evaporated, the thickness of the cast slurry is reduced up to some extent, as the volume of the cast slurry is reduced to provide the volume of the non-sintered metal fiber medium. Alternatively, the binding agent is solidified by cooling the cast slurry, in case the binding agent was heated to reduce its viscosity.

Possibly, the non-sintered metal fiber medium is subjected to a pressing operation, such as a rolling operation, to further reduce the thickness of the non-sintered metal fiber medium.

Possibly, several layers of slurry may be tape cast one on top of the other to form a layered non sintered metal fiber medium. The different layers are not to comprise identical metal fibers, nor should they be of an identical metal fiber content per surface unit or volume. The different layers may differ from each other in metal fibers, metal fiber content, thickness, weight and other properties.

After solidifying of the binding agent, e.g. by drying the tape cast slurry, the metal fibers are mechanically anchored in the medium by means of the binding agent, which acts as a glue between the different metal fibers. In case sufficient binding agent is present in the medium, the voids between the metal fibers may be filled with binding agent.

It is understood that the composition of the non-sintered metal fiber medium may vary over a large extent, by varying the percentage of weight of binding agent and metal fibers in the non-sintered meal fiber medium.

The metal fibers represent at least 0.75% of the weight of the non-sintered metal fiber medium. More preferred, the metal fibers provide more than 5% weight, or even more than 25% weight of the non-sintered metal fiber medium. The metal fibers may provide up to 95% of the weight of the non-sintered metal fiber medium.

Dependent on the thickness and weight per surface unit of the non-sintered metal fiber medium, the non-sintered metal fiber medium will be air permeable to some extent. The non-sintered metal fiber medium may on the other hand be so dense, that it is impermeable for air and behaves like a foil.

It is understood that also other elements may be added to the slurry before tape casting the slurry. Such elements may be e.g. plasticisers, fillers or even metal powders.

Surprisingly it was found that a non-sintered metal fiber medium obtained by using a method as subject of the invention, has an improved homogeneity of its physical properties such as e.g. thickness, surface weight, surface flatness, and fiber distribution over the surface and over the depth of the medium.

The thickness of the non-sintered metal fiber medium may vary over a large range, but relatively thin non-sintered metal fiber medium may be obtained, e.g. non-sintered metal fiber medium with thickness less than or equal to 0.2 mm or even less than or equal to 0.1 mm.

The weight of the non-sintered metal fiber medium as subject of the invention is preferably less than 500 g/m², more preferred less than 400 g/m² or even less than 300 g/m², such as less than 100 g/m² such as about 30 g/m².

The non-sintered metal fiber medium may be used e.g. as an EMI- and/or ESD shielding layer, as part of a composite polymer matrix comprising metal fibers, or in fuel cells.

### BRIEF DESCRIPTION OF THE DRAWINGS

The invention will now be described into more detail with reference to the accompanying drawings wherein

FIGS. 1, and 2 show schematically the steps of methods as subject of the invention.

### DESCRIPTION OF THE PREFERRED EMBODIMENTS OF THE INVENTION

An embodiment of the present invention is described hereinafter.

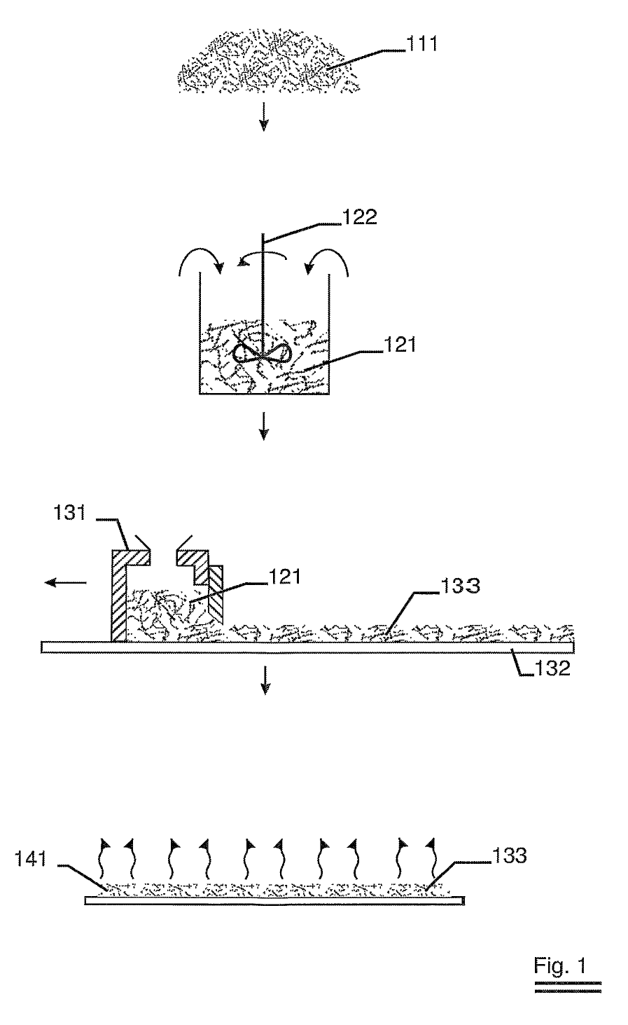

In a method as shown in FIG. 1, in the first step 110 of the method as subject of the invention, metal fibers 111 are provided.

In a next step 120, a slurry 121 was made metal fibers, a binding agent and a solvent preferably water.

This slurry was blend using a blending means 122 several minutes in order to form a substantially stable slurry.

In step 130, the slurry 121 was provided to an applicator 131, being doctor blade and tape cast on a substantially flat and water repellant surface 132. A cast slurry 133 was provided.

In the next step 140, the cast slurry 133 was dried and transformed into a non-sintered metal fiber medium 141, as an example in ambient temperature.

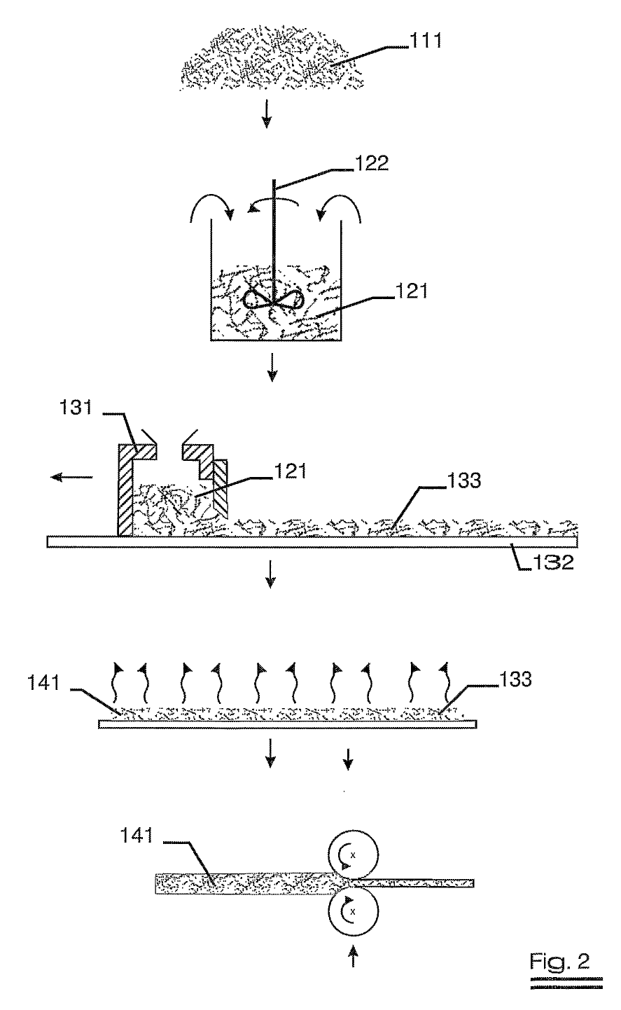

As shown in FIG. 2, an additional step of compressing, e.g. rolling the sintered metal fiber medium 141 in step 210 may be executed. All other steps are identical to the steps as described and shown in FIG. 1.

An embodiment of the present invention may be obtained using the method of FIG. 1 and FIG. 2.

In a first step, metal fibers with equivalent diameter of 2 μm, made by means of bundle drawing processes, are provided. The endless metal fibers are cut into metal fibers having an average length of 109 μm, using the method of WO02/057035. The metal fibers were provided out of AISI 316L alloy.

Hereafter, a slurry was made using following composition:

9.09% weight of the slurry being metal fibers,

1.36% weight of the slurry being methyl cellulose ether (being binding agent)

89.55% weight of the slurry being water (being the solvent).

The slurry was tape cast using a doctor blade having a clearance of 1.5 mm.

Such cast slurry was solidified by drying to the air for about 24 h. Alternatively, IR-radiation may be used to heat the cast slurry and assist the drying operation. A non-sintered metal fiber medium was obtained comprising the binding agent with chemically bound water and metal fibers.

A non-sintered metal fiber medium was obtained having a thickness of 285 μm and having a weight of 105 g/m². The non-sintered metal fiber medium comprised 13% weight of binding agent, and 87% weight of metal fibers.

Using similar steps, a sintered metal fiber product may be obtained, when using metal fibers of 1.5 μm diameter, having a substantially similar L/D.

A non-sintered metal fiber medium was obtained having a thickness of 251 μm and having a weight of 127 g/m². The non-sintered metal fiber medium comprised again 13% weight of binding agent, and 87% weight of metal fibers.

An similar non-sintered metal fiber medium was made using a plasticizer. It was found that the thickness nor weight was influenced.

1. A method for manufacturing a non-sintered metal fiber medium, comprising the steps of:
providing metal fibers;
making a slurry comprising said metal fibers and a binding agent by mixing said metal fibers and said binding agent.;
casting a layer of said slurry on a support using an applicator;
solidifying said slurry, providing a non-sintered metal fiber medium comprising said metal fibers and said binding agent.

2. A method as claimed in claim 1, wherein the concentration of metal fibers in said slurry is in the range of 2% weight to 40% weight of said slurry.

3. A method as claimed in claim 1, wherein said slurry comprising a solvent dissolving said binding agent.

4. A method as claimed in claim 3, wherein said solidifying of said slurry is done by evaporation of all of said solvent from said slurry.

5. A method as claimed in claim 3, wherein said solvent is water.

6. A method as claimed in claim 1, wherein said slurry is provided by heating said binding agent.

7. A method as claimed in claim 1, wherein said method comprises an additional step of reducing the thickness of said non-sintered metal fiber medium by a pressing operation.

8. A method as claimed in claim 1, wherein said method comprises an additional step of casting an additional layers of slurry on a previous layer of solidified slurry.

9. A method as claimed in claim 1, wherein the thickness of said non-sintered metal fiber medium is less than or equal to 0.2 mm.

10. A method as claimed in claim 1, wherein said metal fibers have an equivalent diameter D of less than 6 μm.

11. A method as claimed in claim 1, wherein said metal fibers have an average fiber length L of less than 10 mm.

12. A method as claimed in claim 1, wherein said metal fibers have an L/D of less than 110.

13. A non-sintered metal fiber medium obtainable by means of a method according to claim 1, wherein said metal fibers provide more than 0.75% of the weight of said non-sintered metal fiber medium.
